(19) United States
(12) Patent Application Publication
(10) Pub. No.: US 2008/0095469 A1
(43) Pub. Date: Apr. 24, 2008

(54) Combined Rotation and Scaling

(76) Inventor: Matthew Stephen Kiser, Richardson, TX (US)

Correspondence Address: CONLEY ROSE, P.C., 5601 GRANITE PARKWAY, SUITE 750, PLANO, TX, 75024, US

(21) Appl. No.: 11/551,808

(22) Filed: Oct. 23, 2006

(51) Int. Cl. G06K 9/36

(52) U.S. Cl. 382/289

(57) ABSTRACT

A method for rotating and scaling at least a portion of an image is provided. The method consists of determining symbolically an inverse matrix of a rotation and scaling matrix, using one or more entries in the inverse matrix as variables in a scaling and rotation routine, evaluating the variables with an angle factor and a scaling factor, and using the evaluated variables to specify a location of a screen pixel corresponding to the portion of the image.

### CROSS-REFERENCE TO RELATED APPLICATIONS

None

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Handheld electronic devices such as mobile telephones, personal digital assistants, handheld computers, and similar devices will be referred to herein as handsets. A handset typically has less processing power and less memory capacity than a typical desktop computer. Due to these limited resources, a handset might be incapable of satisfactorily performing certain functions that can be routinely carried out by a desktop computer. Manipulation of graphical images, in particular, might require a greater level of computing resources than are typically available on a handset.

As an example, causing an image on a display screen to simultaneously rotate and change its scale can be computationally intensive. Such a manipulation of an image would typically be done by performing multiple iterations of complicated matrix algebra calculations. A typical desktop computer can perform the calculations quickly enough that an image on the computer's display screen might appear to smoothly rotate and change its size. If similar computations were carried out on a handset, the limited processing resources of the handset might cause jerkiness or other undesirable effects in the motion of the image.

The characteristics of an image that appears on the display screen of a handset or a computer are typically defined by a data file that can be referred to as a bitmap. A bitmap might contain a large number of data elements, each of which specifies the characteristics of a single picture element on a display screen. The data elements in a bitmap will be referred to herein as data pixels. The picture elements on a display screen will be referred to herein as screen pixels.

### SUMMARY

In one embodiment, a method for rotating and scaling at least a portion of an image is provided. The method consists of determining symbolically an inverse matrix of a rotation and scaling matrix, using one or more entries in the inverse matrix as variables in a scaling and rotation routine, evaluating the variables with an angle factor and a scaling factor, and using the evaluated variables to specify a location of a screen pixel corresponding to the portion of the image.

In another embodiment, a system for rotation and scaling of a portion of an image is provided. The system consists of a device having a display, a processor, and a storage device. The storage device is operable to store instructions that, when processed by the processor, are operable for rotation and scaling of the portion of the image. The rotation and scaling are performed by determining symbolically an inverse matrix of a rotation and scaling matrix, using one or more entries in the inverse matrix as variables in a scaling and rotation routine, evaluating the variables with an angle factor and a scaling factor, and using the evaluated variables to specify a location of a screen pixel corresponding to the portion of the image.

In another embodiment, a computer readable medium is provided. The computer readable medium contains instructions that, when processed by a processor, are operable for rotation and scaling of an image. The rotation and scaling are performed by determining symbolically an inverse matrix of a rotation and scaling matrix, using one or more entries in the inverse matrix as variables in a scaling and rotation routine, evaluating the variables with an angle factor and a scaling factor, and using the evaluated variables to specify a location of a screen pixel corresponding to a portion of the image.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a diagram of a handset operable for some of the various embodiments of the disclosure.

FIG. 2 is a diagram of a method for combined rotation and scaling according to an embodiment of the disclosure.

FIG. 3 is a diagram of a wireless communications system including a handset operable for some of the various embodiments of the present disclosure.

FIG. 4 is a block diagram of a handset operable for some of the various embodiments of the present disclosure.

FIG. 5 is a diagram of a software environment that may be implemented on a handset operable for some of the various embodiments of the present disclosure.

### DETAILED DESCRIPTION

It should be understood at the outset that although an illustrative implementation of one embodiment of the present disclosure is illustrated below, the present system may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

It is well known in the art of computer graphics that three general types of manipulation can be performed on a two-dimensional image that appears on a display screen: scaling, or changing the size of the image; translation, or moving the image to a different location on the screen; and rotation of the image through a given angle. Each of these operations can be represented by a matrix that specifies how the image is to be manipulated. For example, it is well known that rotation of an image can be performed with the following matrix, where θ is the angle of rotation:

$$[ \begin{matrix}cos θ & - sin θ & 0 \\ sin θ & cos θ & 0 \\ 0 & 0 & 1\end{matrix} ]$$

It is also well known that scaling can be performed with the following matrix, where Sₓ is a scaling factor in the horizontal direction, S_{y} is a scaling factor in the vertical direction, tₓ is a translation distance in the horizontal direction, and t_{y} is a translation distance in the vertical direction.

$$[ \begin{matrix}{S}_{x} & 0 & {t}_{x} \\ 0 & {S}_{y} & {t}_{y} \\ 0 & 0 & 1\end{matrix} ]$$

A combination of rotation and scaling can be achieved with a matrix derived by the matrix multiplication of the above two matrices. One of skill in the art will recognize that the following matrix, which can be referred to as matrix A, results from multiplication of the above two matrices:

$$[ \begin{matrix}{S}_{x} cos θ & - {S}_{x} sin θ & {t}_{x} \\ {S}_{y} sin θ & {S}_{y} cos θ & {t}_{y} \\ 0 & 0 & 1\end{matrix} ]$$

For lines, polygons, and other simple figures, matrix A is sufficient to perform simultaneous rotation and scaling of an image. However, it is well known in the art that use of matrix A is inadequate when bitmaps and other complex images are to be manipulated. If matrix A is applied to each data pixel in a bitmap that is to be simultaneously scaled and rotated, round off errors may arise that can cause defects, such as holes, to appear in the transformed image.

A well known technique for preventing such defects in the transformed image involves using the inverse of matrix A to map the data pixels in a source bitmap to corresponding data pixels in a transformed bitmap. This ensures that the screen pixels that form the transformed image have the appropriate characteristics. Thus, performing a combined rotation and scaling on a bitmapped image would typically require that every data pixel in the bitmap be processed through the inverse of matrix A.

One of skill in the art will recognize that processing data through the inverse of a 3×3 matrix is a complicated procedure that can involve a large number of multiplication and addition operations. Therefore, under the prior art, a great deal of calculation needed to be performed in a short period of time in order for the combined rotation and scaling of a bitmap to exhibit a satisfactory appearance. The calculations might be carried out through the use of a loop in a software routine. On the first pass through the loop, a first data pixel might be processed as described above, on the second pass, a second data pixel might be processed, and so on, until all data pixels are processed.

Each pass through the loop might require a large number of multiplication and addition operations for each matrix operation and a large number of passes through the loop may be required to process all of the data pixels. These multiple iterations of multiple multiplication and addition operations result in the need for elevated levels of computing resources to perform combined rotation and scaling. A desktop computer might have sufficient computing resources to perform the calculations in a timely manner. A handset, however, might not be able to perform the calculations quickly enough to provide the desired effects.

Embodiments of the present disclosure provide an efficient method for performing a combined rotation and scaling of an image on a display screen. Multiple iterations of processing the data pixels in a source image file through the inverse of matrix A are not performed, as was the case in the prior art. Instead, the inverse of matrix A is determined symbolically and the symbolic entries in the inverse of matrix A are used as variables in a more efficient rotation and scaling routine. This more efficient routine uses a greatly reduced number of multiplication and addition operations compared to the prior art. The term ‘determined symbolically’ should be understood to refer to the process of manipulating the symbols in a matrix without regard to the values that might be assigned to the symbols.

One of skill in the art will recognize that performing the appropriate operations on matrix A will yield the inverse, A⁻¹, of matrix A as follows:

$$[ \begin{matrix}cos θ / {S}_{x} & sin θ / {S}_{y} & - ( {t}_{y} sin θ / {S}_{y} + {t}_{x} cos θ / {S}_{x} ) \\ - sin θ / {S}_{x} & cos θ / {S}_{y} & ( {t}_{x} sin θ / {S}_{x} - {t}_{y} cos θ / {S}_{y} ) \\ 0 & 0 & 1\end{matrix} ]$$

The entries in matrix A⁻¹ can be used as variables in a routine and desired values for rotation and scaling can be assigned to the variables. The routine can evaluate the variables using the assigned values. The numerical results can then be used in a loop that converts the data pixels in a source image file to a scaled and rotated image. Computing the values of certain variables before a loop is entered greatly reduces the number of operations performed within the loop. This, in turn, allows combined rotation and scaling to be performed in far fewer steps compared to the prior art.

The following code is an example of a software routine that might be used to perform combined rotation and scaling in this efficient manner. It should be understood that this code is given only as an example. Other programming languages and other variable names could be used. Steps might be performed in a different order or other steps could be taken to achieve similar results. One of skill in the art will recognize other changes that might be made to this code without substantially changing its function. Also, steps similar to these might be embedded in firmware or other media and might be processed in manners other than as a software routine.

```
#include “stdafx.h”
#include “fixed.h”
#include <math.h>
#include “rawimage.h”
#ifndef M_PI
#define M_PI 3.141592654
#endif
Void IScaleRotate(const rawImage *S,
              rawImage *D,
              unsigned char angle,
              fx_16_16 sx,
              fx_16_16 sy,
              fx_24_8 alphascale) {
  fx_16_16 startx,starty,newx,newy,tx,ty;
  fx_16_16 sinA,cosA,csx,csy,ssx,ssy;
  fx_16_16 dw,dh,sw,sh,two = (2<<16);
  int x,y,ix,iy,dline;
  if (S && D &&
    S->width != 0 && D->width != 0 &&
    S->height != 0 && D->height != 0 &&
    (D->alphaType == bitmapAlpha && D->alpha != NULL)) {
    sinA = fxsin(angle, 16);
    cosA = fxcos(angle, 16);
    csx = fxdiv_16_16(cosA,sx);
    csy = fxdiv_16_16(cosA,sy);
    ssx = fxdiv_16_16(sinA,sx);
    ssy = fxdiv_16_16(sinA,sy);
    dw = D->width<<15;
    dh = D->height<<15;
    sw = fxmul_16_16((S->width<<15),sx);
    sh = fxmul_16_16((S->height<<15),sy);
    tx = dw − (fxmul_16_16(sw,cosA) − fxmul_16_16(sh,sinA));
    ty = dh − (fxmul_16_16(sw,sinA) + fxmul_16_16(sh,cosA));
    newx = startx = −(fxmul_16_16(ssy,ty) + fxmul_16_16(csx,tx));
    newy = starty = fxmul_16_16(ssx,tx) − fxmul_16_16(csy,ty);
    for(dline=0,y=0;y<(int)D->height;y++,dline+=D->width) {
      for(x=0;x<(int)D->width;x++,newx+=csx,newy−=ssx) {
        ix = (int) (newx >> 16);
        iy = (int) (newy >> 16);
        if(ix>=0 && ix < (int)S->width − 1 && iy >= 0 && iy <(int)S->height − 1) {
          if (newx & 0x00008000)
            ix++;
          if (newy & 0x00008000)
            iy++;
          D->pdata[dline+x] = S->pdata[iy * S->width + ix];
          if (D->alphaType == bitmapAlpha)
            if (S->alpha[iy * S->width + ix] != 0)
              D->alpha[dline+x] = (S->alpha[iy*S->width + ix]*alphascale>>8;
            else
              D->alpha[dline+x] = 0;
        }else
          D->pdata[dline+x] = 0;
      }
      newy = starty += csy;
      newx = startx += ssy;
    }
  }
}
```

It can be seen, in lines 10 through 15, that values for the variables ‘angle’, ‘sx’, and ‘sy’ can be passed into the function IScaleRotate. These variables are equivalent to the variables θ, Sₓ, and S_{y}, respectively in matrix A⁻¹. In lines 30 through 33, the variables csx, csy, ssx, and ssy are defined. It can be seen that these variables are equivalent, respectively, to the cos θ/Sₓ, cos θ/S_{y}, sin θ/Sₓ, and sin θS_{y} entries in matrix A⁻¹. In lines 44 and 45, the variables newx and newy are defined. It can be seen that these variables are equivalent, respectively, to the −(t_{y} sin θ/S_{y}+tₓ cos θ/Sₓ) and (tₓ sin θ/Sₓ−t_{y} cos θ/S_{y}) entries in matrix A⁻¹.

Thus, values for the entries in matrix A⁻¹ are either assigned or calculated before the “for” loop shown in lines 47 through 70 is entered. This “for” loop performs the actual task of iteratively retrieving data pixels from a source image file and causing an image to appear on a display screen with the appropriate rotation and scaling. It can be seen that, with the “for” loop beginning at line 48 being nested within the “for” loop beginning at line 47, a very large number of iterations of the “for” loop beginning at line 47 might occur. Under the prior art, multiple variables might be evaluated by means of matrix operations during each pass through a set of “for” loops such as these. By performing the evaluation of several variables outside these “for” loops, the present method eliminates the use of matrices within the “for” loops and greatly reduces the number of operations performed within the “for” loops. This reduces the amount of time needed to perform the “for” loops and, in turn, allows combined rotation and scaling of an image to be performed on a handset with limited computing resources.

Several other factors promote more efficient rotation and scaling with the present method. First, it can be seen that no multiplication operations are performed within the “for” loops. Instead, the ‘csx’ and ‘ssx’ variables are merely incremented in line 48. It is well known that incrementation is less computationally intensive than multiplication.

Also, one of skill in the art will recognize that matrix A⁻¹ contains several zeroes. When a routine evaluates this matrix, calculations involving zeroes will be performed even though the results of the calculations will have no effect on the final result. By determining A⁻¹ symbolically before entering a “for” loop rather than performing an inverse matrix operation within a “for” loop, calculations involving zeroes need not be performed and several steps that might be taken in prior methods can be eliminated.

In addition, the calculations in the present method can be performed without the use of floating point math. One of skill in the art will recognize that this can increase the efficiency of the calculations performed in the present method.

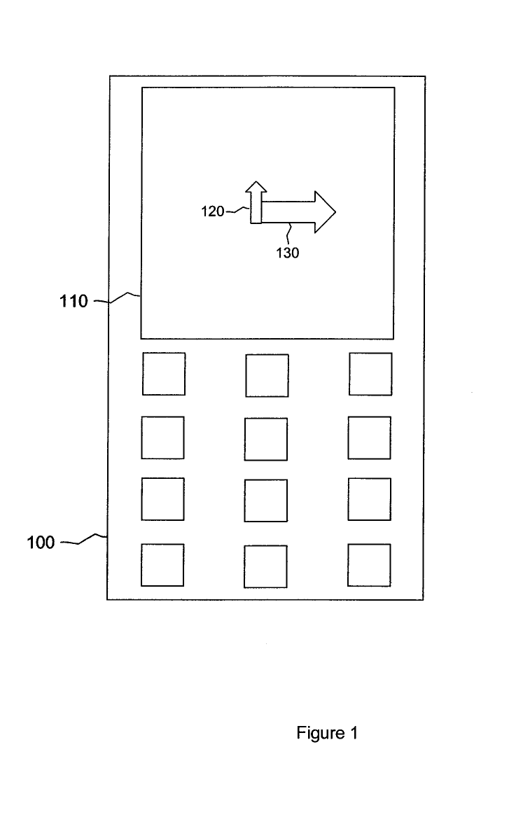

FIG. 1 illustrates a handset 100 on which embodiments of the present disclosure might be implemented. The handset 100 includes a display screen 110 on which graphical images might be displayed. In this example, the screen 110 contains an original image 120 on which a combined rotation and change of scale might be performed. A transformed image 130 illustrates an image that might result from one particular combination of rotation and change of scale. In this example, the original image 120 has rotated by 90 degrees and doubled in both length and width.

The display of the original image 120 on the screen 110 is typically accomplished by retrieving a first data pixel from a data file associated with the original image 120. This first data pixel might specify the characteristics of a first screen pixel on the screen 110. A second data pixel might then be retrieved and used to specify the characteristics of a second screen pixel. Remaining portions of the data file might continue to be retrieved until the entirety of the original image 120 is displayed.

If the original image 120 is to be transformed into the transformed image 130, a combined rotation and scaling might be performed on the data pixels in the data file associated with the original image 120. In an embodiment, a routine such as that given in the above example might be used to perform the rotation and scaling. For example, the 90 degree rotation and the doubling in length and width might be done by assigning a value of 90 to the ‘angle’ variable, a value of 2 to the ‘sx’ variable, and a value of 2 to the ‘sy’ variable in the routine. The routine might then use these values to calculate values for the entries in matrix A⁻¹. These values, in turn, might be used in the set of “for” loops that convert the data pixels in the data file into the screen pixels that represent the transformed image 130.

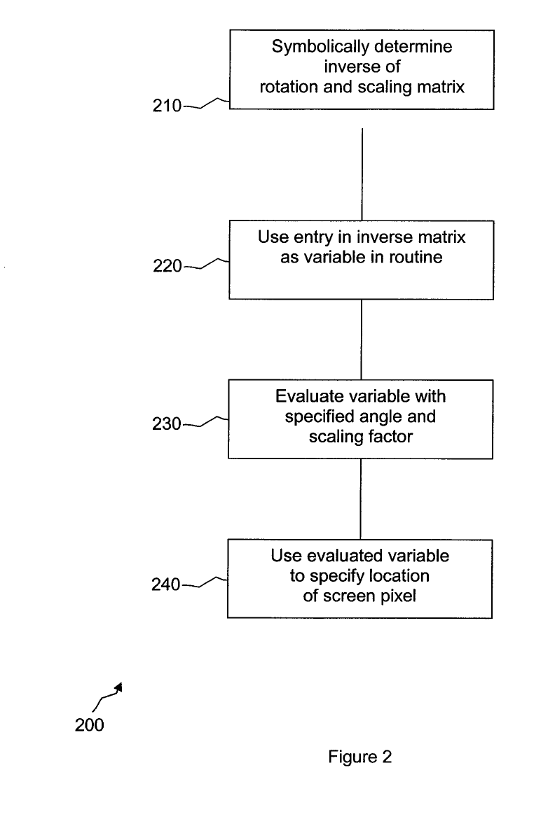

FIG. 2 illustrates a method 200 for performing a combined rotation and scaling on an image on a display screen. In box 210, the inverse of a rotation and scaling matrix is determined symbolically. In box 220, an entry in the inverse matrix is used as a variable in a routine such as a set of instructions or a software routine. In box 230, the variable in the routine is evaluated with a specified angle and scaling factor. In box 240, the evaluated variable is used to specify the location of a screen pixel.

While the above discussion has focused on a combination of rotation and scaling, one of skill in the art will recognize that similar considerations would apply to a combination of rotation and translation, a combination of scaling and translation, and a combination of rotation, scaling, and translation. Also, while the present method has been described in conjunction with a handset, it should be recognized that the method could also be implemented on a desktop computer or other data processing device.

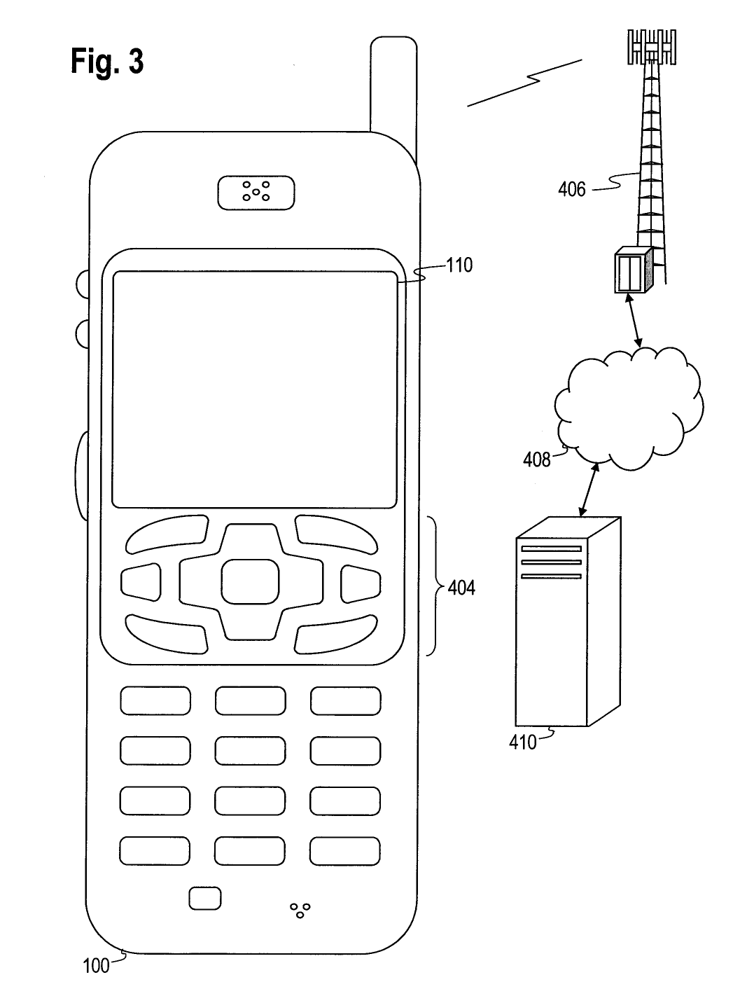

FIG. 3 shows a wireless communications system including the handset 100. The handset 100 is operable for implementing aspects of the present disclosure, but the present disclosure should not be limited to these implementations. Though illustrated as a mobile phone, the handset 100 may take various forms including a wireless handset, a pager, a personal digital assistant (PDA), a portable computer, a tablet computer, or a laptop computer. Many suitable handsets combine some or all of these functions. In some embodiments of the present disclosure, the handset 100 is not a general purpose computing device like a portable, laptop or tablet computer, but rather is a special-purpose communications device such as a mobile phone, wireless handset, pager, or PDA.

The handset 100 includes the display 110 and a touch-sensitive surface or keys 404 for input by a user. The handset 100 may present options for the user to select, controls for the user to actuate, and/or cursors or other indicators for the user to direct. The handset 100 may further accept data entry from the user, including numbers to dial or various parameter values for configuring the operation of the handset 100. The handset 100 may further execute one or more software or firmware applications in response to user commands. These applications may configure the handset 100 to perform various customized functions in response to user interaction.

Among the various applications executable by the handset 100 are a web browser, which enables the display 110 to show a web page. The web page is obtained via wireless communications with a cell tower 406, a wireless network access node, or any other wireless communication network or system. The cell tower 406 (or wireless network access node) is coupled to a wired network 408, such as the Internet. Via the wireless link and the wired network, the handset 100 has access to information on various servers, such as a server 410. The server 410 may provide content that may be shown on the display 110.

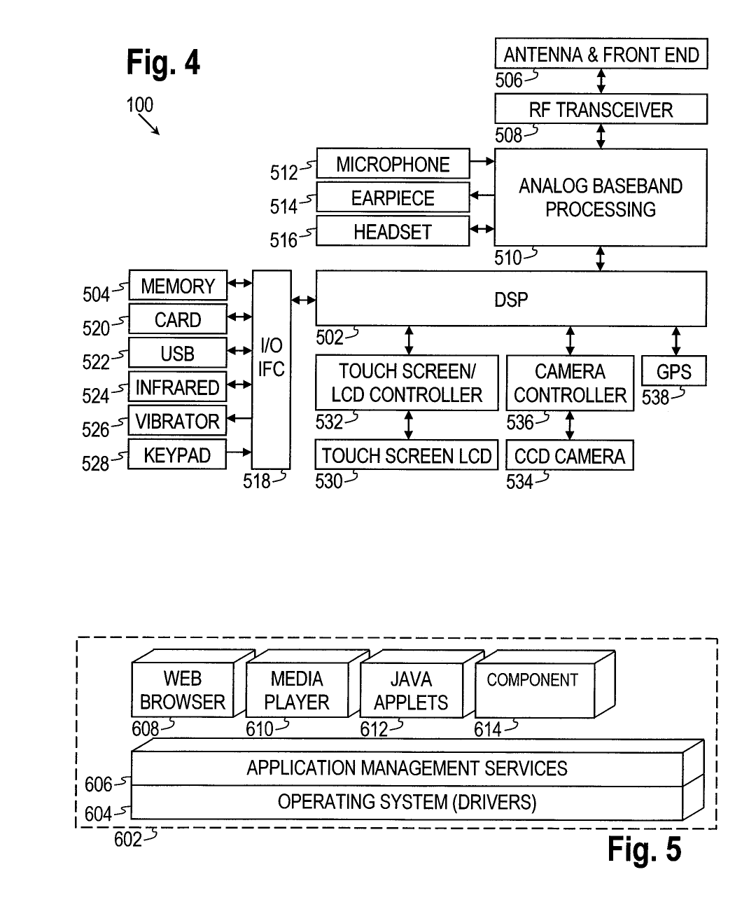

FIG. 4 shows a block diagram of the handset 100. The handset 100 includes a digital signal processor (DSP) 502 and a memory 504. As shown, the handset 100 may further include an antenna and front end unit 506, a radio frequency (RF) transceiver 508, an analog baseband processing unit 510, a microphone 512, an earpiece speaker 514, a headset port 516, an input/output interface 518, a removable memory card 520, a universal serial bus (USB) port 522, an infrared port 524, a vibrator 526, a keypad 528, a touch screen liquid crystal display (LCD) with a touch sensitive surface 530, a touch screen/LCD controller 532, a charge-coupled device (CCD) camera 534, a camera controller 536, and a global positioning system (GPS) sensor 538.

The DSP 502 or some other form of controller or central processing unit operates to control the various components of the handset 100 in accordance with embedded software or firmware stored in memory 504. In addition to the embedded software or firmware, the DSP 502 may execute other applications stored in the memory 504 or made available via information carrier media such as portable data storage media like the removable memory card 520 or via wired or wireless network communications. The application software may comprise a compiled set of machine-readable instructions that configure the DSP 502 to provide the desired functionality, or the application software may be high-level software instructions to be processed by an interpreter or compiler to indirectly configure the DSP 502.

The antenna and front end unit 506 may be provided to convert between wireless signals and electrical signals, enabling the handset 100 to send and receive information from a cellular network or some other available wireless communications network. The RF transceiver 508 provides frequency shifting, converting received RF signals to baseband and converting baseband transmit signals to RF. The analog baseband processing unit 510 may provide channel equalization and signal demodulation to extract information from received signals, may modulate information to create transmit signals, and may provide analog filtering for audio signals. To that end, the analog baseband processing unit 510 may have ports for connecting to the built-in microphone 512 and the earpiece speaker 514 that enable the handset 100 to be used as a cell phone. The analog baseband processing unit 510 may further include a port for connecting to a headset or other hands-free microphone and speaker configuration.

The DSP 502 may send and receive digital communications with a wireless network via the analog baseband processing unit 510. In some embodiments, these digital communications may provide Internet connectivity, enabling a user to gain access to content on the Internet and to send and receive e-mail or text messages. The input/output interface 518 interconnects the DSP 502 and various memories and interfaces. The memory 504 and the removable memory card 520 may provide software and data to configure the operation of the DSP 502. Among the interfaces may be the USB interface 522 and the infrared port 524. The USB interface 522 may enable the handset 100 to function as a peripheral device to exchange information with a personal computer or other computer system. The infrared port 524 and other optional ports such as a Bluetooth interface or an IEEE 802.11 compliant wireless interface may enable the handset 100 to communicate wirelessly with other nearby handsets and/or wireless base stations.

The input/output interface 518 may further connect the DSP 502 to the vibrator 526 that, when triggered, causes the handset 100 to vibrate. The vibrator 526 may serve as a mechanism for silently alerting the user to any of various events such as an incoming call, a new text message, and an appointment reminder.

The keypad 528 couples to the DSP 502 via the interface 518 to provide one mechanism for the user to make selections, enter information, and otherwise provide input to the handset 100. Another input mechanism may be the touch screen LCD 530, which may also display text and/or graphics to the user. The touch screen LCD controller 532 couples the DSP 502 to the touch screen LCD 530.

The CCD camera 534 enables the handset 100 to take digital pictures. The DSP 502 communicates with the CCD camera 534 via the camera controller 536. The GPS sensor 538 is coupled to the DSP 502 to decode global positioning system signals, thereby enabling the handset 100 to determine its position. Various other peripherals may also be included to provide additional functions, e.g., radio and television reception.

FIG. 5 illustrates a software environment 602 that may be implemented by the DSP 502. The DSP 502 executes operating system drivers 604 that provide a platform from which the rest of the software operates. The operating system drivers 604 provide drivers for the handset hardware with standardized interfaces that are accessible to application software. The operating system drivers 604 include application management services (“AMS”) 606 that transfer control between applications running on the handset 100. Also shown in FIG. 5 are a web browser application 608, a media player application 610, and Java applets 612. The web browser application 608 configures the handset 100 to operate as a web browser, allowing a user to enter information into forms and select links to retrieve and view web pages. The media player application 610 configures the handset 100 to retrieve and play audio or audiovisual media. The Java applets 612 configure the handset 100 to provide games, utilities, and other functionality. A component 614 might implement the scaling and rotation as described above.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A method for rotating and scaling at least a portion of an image, comprising:
determining symbolically an inverse matrix of a rotation and scaling matrix;
using one or more entries in the inverse matrix as variables in a scaling and rotation routine;
evaluating the variables with an angle factor and a scaling factor; and
using the evaluated variables to specify a location of a screen pixel corresponding to the portion of the image.

2. The method of claim 1, further comprising:
determining a scaling matrix; and
determining a rotation matrix.

3. The method of claim 2 wherein the scaling matrix is:
$$[ \begin{matrix}{S}_{x} & 0 & {t}_{x} \\ 0 & {S}_{y} & {t}_{y} \\ 0 & 0 & 1\end{matrix} ]$$
and wherein the rotation matrix is:
$$[ \begin{matrix}cos θ & - sin θ & 0 \\ sin θ & cos θ & 0 \\ 0 & 0 & 1\end{matrix} ] .$$

4. The method of claim 3 wherein a rotation and scaling matrix based on the scaling matrix and the rotation matrix is:
$$[ \begin{matrix}{S}_{x} cos θ & - {S}_{x} sin θ & {t}_{x} \\ {S}_{y} sin θ & {S}_{y} cos θ & {t}_{y} \\ 0 & 0 & 1\end{matrix} ] .$$

5. The method of claim 4 wherein the inverse matrix based on the rotation and scaling matrix is:
$$[ \begin{matrix}cos θ / {S}_{x} & sin θ / {S}_{y} & - ( {t}_{y} sin θ / {S}_{y} + {t}_{x} cos θ / {S}_{x} ) \\ - sin θ / {S}_{x} & cos θ / {S}_{y} & ( {t}_{x} sin θ / {S}_{x} - {t}_{y} cos θ / {S}_{y} ) \\ 0 & 0 & 1\end{matrix} ] .$$

6. The method of claim 5, wherein at least some of the variables in the scaling and rotation routine include cos θ/Sₓ, cos θ/S_{y}, sin θ/Sₓ, and sin θ/S_{y} from the inverse matrix.

7. The method of claim 5 further comprising reducing a number of computations necessary to accomplish the rotation and scaling of the portion of the image by considering elements of the inverse matrix having a value of zero.

8. A system for rotation and scaling of a portion of an image, comprising:
a device having:
a display,
a processor, and
a storage device operable to store instructions that, when processed by the processor, are operable for rotation and scaling of the portion of the image by:
determining symbolically an inverse matrix of a rotation and scaling matrix,
using one or more entries in the inverse matrix as variables in a scaling and rotation routine,
evaluating the variables with an angle factor and a scaling factor, and
using the evaluated variables to specify a location of a screen pixel corresponding to the portion of the image.

9. The system of claim 8, wherein the device is one of: a desktop computer, a laptop computer, a portable computer, a workstation computer, and a server.

10. The system of claim 8, wherein the device is one of: a mobile handset and a personal digital assistant.

11. The system of claim 8, wherein a scaling matrix and a rotation matrix are determined.

12. The system of claim 11 wherein the scaling matrix is:
$$[ \begin{matrix}{S}_{x} & 0 & {t}_{x} \\ 0 & {S}_{y} & {t}_{y} \\ 0 & 0 & 1\end{matrix} ]$$
and wherein the rotation matrix is:
$$[ \begin{matrix}cos θ & - sin θ & 0 \\ sin θ & cos θ & 0 \\ 0 & 0 & 1\end{matrix} ] .$$

13. The system of claim 12 wherein a rotation and scaling matrix based on the scaling matrix and the rotation matrix is:
$$[ \begin{matrix}{S}_{x} cos θ & - {S}_{x} sin θ & {t}_{x} \\ {S}_{y} sin θ & {S}_{y} cos θ & {t}_{y} \\ 0 & 0 & 1\end{matrix} ] .$$

14. The system of claim 13 wherein the inverse matrix based on the rotation and scaling matrix is:
$$[ \begin{matrix}cos θ / {S}_{x} & sin θ / {S}_{y} & - ( {t}_{y} sin θ / {S}_{y} + {t}_{x} cos θ / {S}_{x} ) \\ - sin θ / {S}_{x} & cos θ / {S}_{y} & ( {t}_{x} sin θ / {S}_{x} - {t}_{y} cos θ / {S}_{y} ) \\ 0 & 0 & 1\end{matrix} ] .$$

15. The system of claim 14, wherein at least some of the variables in the scaling and rotation routine include cos θ/Sₓ, cos θ/S_{y}, sin θ/Sₓ, and sin θ/S_{y} from the inverse matrix.

16. The system of claim 14, wherein a number of computations necessary to accomplish the rotation and scaling of the portion of the image is reduced by considering elements of the inverse matrix having a value of zero.

17. A computer readable medium containing instructions that, when processed by a processor, are operable for rotation and scaling of an image by:
determining symbolically an inverse matrix of a rotation and scaling matrix;
using one or more entries in the inverse matrix as variables in a scaling and rotation routine;
evaluating the variables with an angle factor and a scaling factor; and
using the evaluated variables to specify a location of a screen pixel corresponding to a portion of the image.

18. The computer readable medium of claim 17, wherein the instructions further comprise:
determining a scaling matrix wherein the scaling matrix is:
$$[ \begin{matrix}{S}_{x} & 0 & {t}_{x} \\ 0 & {S}_{y} & {t}_{y} \\ 0 & 0 & 1\end{matrix} ]$$
and determining a rotation matrix wherein the rotation matrix is:
$$[ \begin{matrix}cos θ & - sin θ & 0 \\ sin θ & cos θ & 0 \\ 0 & 0 & 1\end{matrix} ] .$$

19. The computer readable medium of claim 18 wherein a rotation and scaling matrix based on the scaling matrix and the rotation matrix is:
$$[ \begin{matrix}{S}_{x} cos θ & - {S}_{x} sin θ & {t}_{x} \\ {S}_{y} sin θ & {S}_{y} cos θ & {t}_{y} \\ 0 & 0 & 1\end{matrix} ]$$

20. The computer readable medium of claim 19 wherein the inverse matrix based on the rotation and scaling matrix is:
$$[ \begin{matrix}cos θ / {S}_{x} & sin θ / {S}_{y} & - ( {t}_{y} sin θ / {S}_{y} + {t}_{x} cos θ / {S}_{x} ) \\ - sin θ / {S}_{x} & cos θ / {S}_{y} & ( {t}_{x} sin θ / {S}_{x} - {t}_{y} cos θ / {S}_{y} ) \\ 0 & 0 & 1\end{matrix} ] .$$
